(19) United States
(12) Patent Application Publication
(10) Pub. No.: US 2026/0225580 A1
(43) Pub. Date: Aug. 6, 2026

(54) METHOD AND SYSTEM FOR MANAGING AT LEAST ONE SERVICE FOR A MOTOR VEHICLE

(71) Applicant: Robert Bosch GmbH, Stuttgart (DE)

(72) Inventors: Rolf Nicodemus, Bietigheim-Bissingen (DE); Stefan Nordbruch, Leonberg (DE)

(21) Appl. No.: 19/127,982

(22) PCT Filed: Jan. 24, 2024
(86) PCT No.: PCT/EP2024/051639

§ 371 Date: May 7, 2025

(30) Foreign Application Priority Data
Feb. 9, 2023 (DE) 10 2023 201 049.6

(51) Int. Cl. B60W 30/06; B60S 5/00

(52) U.S. Cl. CPC B60W 30/06; B60S 5/00; B60W 2510/02; B60W 2510/18; B60W 2510/20; B60W 2510/30; B60W 2530/201; B60W 2554/40; B60W 2556/45

(57) ABSTRACT

A method for managing at least one service for a motor vehicle. The method includes: receiving a request to carry out an AVP process for a motor vehicle to be parked within a parking lot by a service management platform; inquiring of an AVP service system by the service management platform whether the AVP service system can carry out the AVP process for the motor vehicle based on the request to carry out an AVP process within the parking lot; receiving a response from the AVP service system by the service management platform to the inquiry from the service management platform; responding to the request to carry out an AVP process by the service management platform based on the response from the AVP service system. A system for managing at least one service for a motor vehicle, a computer program, and a machine-readable storage medium, are also described.

### FIELD

The present invention relates to a method and a system for managing at least one service for a motor vehicle, a computer program and a machine-readable storage medium.

### BACKGROUND INFORMATION

German Patent Application No. DE 10 2012 222 562 A1 describes a system for managed parking areas for transferring a vehicle from a starting position to a target position.

The current AVP is a service in which the customer books automated parking through a system and has said system carry it out.

Among other things, this requires data from the driver or owner and the vehicle: for example, for payment, for access to the vehicle (certificates and/or passwords and/or access keys), for the duration of (planned) parking, etc.

There is a need for other services, such as charging a drive battery, cleaning, repair, software updates, to be offered during parking.

These services have to also be ordered and likewise require data. However, the data needed is not always all of the data or different data.

These services are moreover not always offered by an individual operator due to the variety of applications from different providers.

For the driver/owner or person ordering the service or services, ordering would be tedious (not every service individually and possibly from different providers).

It can also be assumed that said individual is not willing for all providers to be given the same or all of the data.

### SUMMARY

An object of the present invention is to provide a concept for efficiently managing at least one service for a motor vehicle.

This object is achieved by certain features of the present invention. Advantageous embodiments of the present invention are disclosed herein.

According to a first aspect of the present invention, a method for managing at least one service for a motor vehicle is provided. According to an example embodiment of the present invention, the method comprises the following steps:
receiving a request to carry out an AVP process for a motor vehicle to be parked within a parking lot by a service management platform,
inquiring of an AVP service system by the service management platform whether the AVP service system can carry out the AVP process for the motor vehicle based on the request to carry out an AVP process within the parking lot,
receiving a response from the AVP service system by the service management platform to the inquiry from the service management platform, responding to the request to carry out an AVP process by the service management platform based on the response from the AVP service system.

According to a second aspect of the present invention, a system for managing at least one service for a motor vehicle is provided, which comprises a service management platform configured to carry out all steps of the method according to the first aspect of the present invention.

According to a third aspect of the present invention, a computer program is provided which comprises instructions that, when the computer program is executed by a computer, for example by the system according to the second aspect, cause said computer to carry out a method according to the first aspect of the present invention.

According to a fourth aspect of the present invention, a machine-readable storage medium is provided, on which the computer program according to the third aspect of the present invention is stored.

The present invention is based on and includes the realization that the above task is achieved by providing a service management platform that manages the service or services for the motor vehicle. Specifically, it is provided that the AVP service system handles the implementation of the driving task of the motor vehicle. This means that the AVP service system is responsible only for the implementation of the driving task of the motor vehicle. The function of the AVP service system is therefore only to implement the driving task. The AVP service system has no further tasks. Such further tasks include, for example, requesting payment data and/or requesting additional data needed for the technical implementation of the AVP process.

These further tasks are in particular outsourced to the service management platform. This is therefore the point of contact for the AVP service. This means that the service management platform receives the request to carry out an AVP process instead of the AVP service system and then requests and/or coordinates everything necessary with the AVP service system. A client or a sender of the request to carry out the AVP process therefore only has the service management platform as the sole point of contact and not the AVP service system.

This advantageously provides a concept that advantageously allows the number of services to be scaled efficiently, because, from the perspective of the client or the sender, only one request to carry out a service and only one contact person is needed: the service management platform. This means that a driver of the motor vehicle who wants to order different services for his motor vehicle while the motor vehicle is within the parking lot does not have to communicate with different service systems, but only with a single entity: the service management platform. This makes it significantly easier for the driver of the motor vehicle or the client to order the services he wants. For example, he does not have to enter his data every single time for each individual service; he only has to provide it once to the service management platform. This advantageously saves time.

On the one hand, this means that there is a service management platform via which a service, in this case in particular an AVP service, can be ordered. This service management platform can, for example, receive all of the needed data. Such data includes, for example, payment data, access data for accessing a motor vehicle component, certificates and/or passwords and/or access keys. There is also a system that is separate from the service management platform: the AVP service system that implements the actual driving/parking task. The AVP service system therefore no longer has to handle the aforementioned tasks, such as payment tasks, so that the AVP service system requires correspondingly fewer hardware and/or software resources.

In one example embodiment of the method of the present invention, it is provided that, upon a positive response from the AVP service system, data needed to carry out the AVP process are forwarded by the service management platform to the AVP service system if such data are already included in the request to carry out an AVP process, wherein, if data for the technical implementation of the AVP process are still missing, these still missing data are requested by the service management platform and, after receipt of the still missing data, these data are forwarded by the service management platform to the AVP service system.

This, for example, produces the technical advantage that the needed data or the still missing data can be efficiently made available to the AVP service system. This means that the AVP service system does not itself have to request this data, because the service management platform takes care of this.

A positive response within the meaning of the description refers to a response which indicates that the respective or corresponding service can be carried out.

In one example embodiment of the method of the present invention, it is provided that at least one further request to carry out a specific service for the motor vehicle is received by the service management platform while the motor vehicle is within the parking lot, wherein the service management platform inquires of a further service system for carrying out the specific service whether the further service system can carry out the specific service based on the respective request while the motor vehicle is within the parking lot, wherein, upon a positive response, a stay of the motor vehicle is coordinated by the service management platform based on the request to carry out an AVP process and based on the at least one further request to carry out a specific service in order to enable both the carrying out of the AVP process by the AVP service system and the carrying out of the specific service by the further service system.

This, for example, produces the technical advantage that further services can be carried out efficiently. According to this example embodiment, it is therefore provided that the service management platform handles the management of multiple services. The service management platform therefore serves here as well as the sole point of contact for ordering the individual services. This means, for example, that a driver of the motor vehicle does not have to communicate directly with the individual service systems to inquire whether the respective service is even possible or not. It is therefore sufficient for the client to provide his data to the service management platform once. The service management platform then decides which of these data to forward to which service system so that it can carry out the respective service. For example, a service system that is supposed to wash the motor vehicle as a service does not need access to the motor vehicle's drive system. The AVP service system, on the other hand, needs access to the motor vehicle's drive system in order to carry out the AVP process. The service management platform therefore sends a certificate and/or password and/or access key by means of which the AVP service system can gain access to the motor vehicle's drive system only to the AVP service system, for instance, and not to the service system for carrying out a motor vehicle wash as a service. The same applies to other motor vehicle components needed for the AVP process, such as the steering system, clutch system and brake system.

Because the service management platform coordinates the motor vehicle's stay within the parking space in such a way that both the AVP process and the specific service can be carried out, the motor vehicle's stay within the parking space can be managed efficiently. While the motor vehicle is within the parking lot, the driver of the motor vehicle does not need his motor vehicle, so that the corresponding length of the stay can be used efficiently.

In one example embodiment of the method of the present invention, it is provided that the coordinating includes the service management platform communicating a time of day and/or date to the AVP service system at which or on which the motor vehicle must be at a predetermined location in the parking lot at which the specific service is to be carried out by the further service system, so that the AVP service system can guide the motor vehicle in an at least highly automated manner to the predetermined location on time.

This, for example, produces the technical advantage that the respective services can be carried out on time.

In one example embodiment of the method of the present invention, it is provided that a plurality of further requests to carry out a respective specific service for the motor vehicle are received by the service management platform, wherein a plurality of respective further service systems for carrying out the respective specific service are inquired of by the service management platform whether the respective further service system can carry out the specific service based on the corresponding request, wherein, upon at least two positive responses, the coordinating includes the service management platform determining, based on at least one service parameter, a sequence according to which the services for the motor vehicle are to be carried out by the respective further service system.

This, for example, produces the technical advantage that the individual services can be carried out efficiently. Taking into account at least one service parameter when determining the sequence makes it possible to efficiently and advantageously take into account external circumstances and a specific given situation.

Coordinating includes, for example, an inquiry from the service management platform, in particular an inquiry of the client, if not all of the requested services can be implemented or carried out, which service or services have which priority or which service or services should be carried out no matter what.

Coordinating is carried out based on a respective priority, for instance, which is included in the respective request and which specifies the priority and/or the sequence in which the service or services are to be carried out.

In one example embodiment of the method of the present invention, it is provided that the at least one service parameter is in each case an element selected from the following group of service parameters: utilization of the service systems; utilization of the AVP service system; capacity of the service systems; capacity of the AVP service system; current and/or future traffic within the parking lot; parking position of the motor vehicle within the parking lot; the predetermined locations; expected duration of carrying out one of the services.

This, for example, produces the technical advantage that particularly suitable service parameters can be provided.

A utilization and/or capacity of the service systems are requested from the corresponding service system by the service management platform, for example. The same applies analogously to the current and/or future traffic within the parking lot and the parking position of the motor vehicle. This information is requested by the service management platform from the AVP service system, for instance. An expected duration of carrying out the service, for example the AVP service, is requested by the service management platform, for instance from the corresponding service system, for example the AVP service system.

In one example embodiment of the method of the present invention, it is provided that, upon a positive response from the respective further service system, data needed to carry out the respective further service are forwarded by the service management platform to the respective service system if such data are already included in the respective at least one further request to carry out a specific service, wherein, if data for the technical implementation of the respective further service are still missing, these still missing data are requested by the service management platform and after receipt of the still missing data, these data are forwarded by the service management platform to the respective service system.

This, for example, produces the technical advantage that the needed data or the still missing data can be forwarded efficiently to the AVP service system.

In one example embodiment of the method of the present invention, it is provided that the needed data or the still missing data comprise one or more elements of the following data: motor vehicle length; motor vehicle width; motor vehicle height; certificate and/or password and/or access key for accessing a motor vehicle component, in particular drive system, brake system, steering system, clutch system, lighting system, door lock, tank lock, charging opening lock, charging component, trunk lock, engine compartment lock, control unit, main control unit, which is needed to carry out the service or the AVP process; motor vehicle turning radius; driving characteristics of the motor vehicle; level of automation.

This, for example, produces the technical advantage that particularly suitable data are available for carrying out the respective services.

Many of the data within the meaning of the description comprise data that has not yet been transmitted as part of the request, for instance, for example the further request.

The still missing data are requested from the sender of the original request or the further request, for example. Still missing data can be requested directly from the motor vehicle, for instance. This then independently sends the still missing data to the service management platform. This means that the service management platform can receive the still missing data from the motor vehicle, for example.

In one example embodiment of the method of the present invention, it is provided that the service management platform, the AVP service system and the service system or the service systems are respectively implemented in a separate cloud infrastructure and/or in a common cloud infrastructure and/or in a stand-alone server and/or in a separate virtual machine.

This, for example, produces the technical advantage that the respective entities, i.e. the service management platform, the AVP service system, and the service system or service systems are implemented efficiently. Implementing these in both a cloud infrastructure and a virtual machine, for example, advantageously achieves redundancy. This means that the use of “and” with respect to the above options can efficiently achieve redundancy in the implementations.

In one example embodiment of the method of the present invention, it is provided that the service or services is/are in each case an element selected from the following group of services: washing the motor vehicle; cleaning an interior of the motor vehicle; repairing the motor vehicle; servicing the motor vehicle; charging a drive battery of the motor vehicle;

refueling, in particular with gasoline, diesel, hydrogen, combustible gas; software update for software running on an electronic component of the motor vehicle; tire change; interior service, in particular arranging mail and/or package(s) in the interior.

This, for example, produces the technical advantage that particularly suitable services can be provided.

In the light of the above and/or following statements, an AVP service is also a service and an AVP service system is also a service system. For this reason, a further service and a further service system were also mentioned when they were defined for the first time.

The system according to the second aspect of the present invention is, for example, programmed to execute the computer program according to the third aspect.

The service management platform is, for example, configured to execute the computer program according to the third aspect.

The method according to the first aspect of the present invention is a computer-implemented method, for instance.

According to one example embodiment of the present invention, the system according to the second aspect comprises the AVP service system and/or the at least one further service system.

The service management platform and the AVP service system, and optionally the service system or service systems, are connected to one another, for example via one or more communication networks, and thus communicate, for example via the communication network or communication networks. Communicating includes sending and/or receiving requests and/or responses, for instance.

A communication network is a wired or a wireless communication network, for example. A wired communication network is, for instance, an ETHERNET communication network. A wireless communication network is, for example, a WLAN network or a cellular network.

Statements made in connection with the system of the present invention apply analogously to the method of the present invention and vice versa. This means that system features result from corresponding method features and vice versa.

The embodiments and embodiment examples described here can be combined with one another in the usual manner, even if this is not explicitly stated.

The phrase “at least one” means “one or more”.

Statements made in connection with one service apply analogously to multiple services and vice versa.

Receiving and/or requesting and/or responding within the meaning of the description is carried out via one or more communication networks, for instance.

The abbreviation “AVP” stands for “automated valet parking” and can be translated into German as “automatischer Parkservice” (automated parking service). An AVP process, for example, includes at least highly automated guidance of the motor vehicle from a drop zone, also known as a drop-off position, to a parking position, and, for example, at least highly automated guidance of the motor vehicle from a parking position to a pick-up position, also known as a pick-up zone. At the drop-off position, i.e. the drop zone, a driver of the motor vehicle drops the motor vehicle off for an AVP process. At a pick-up position, i.e. the pick-up zone, the motor vehicle is picked up after the end of the AVP process. An AVP process therefore starts in particular at the drop zone. An AVP process therefore ends in particular at the pick-up zone.

An AVP motor vehicle is therefore a motor vehicle that can participate in an AVP process. When the term “motor vehicle” is used above and in the following, it should always be understood that this is an AVP motor vehicle, even if the term “AVP” is not explicitly used.

In one example embodiment of the method of the present invention, an infrastructure-side AVP system is provided. The AVP process is in particular carried out using the infrastructure-side AVP system.

An AVP process can be an AVP process according to one of the following AVP types: AVP type 1, AVP type 2, and AVP type 3. It is, however, also possible that the AVP types change within an AVP process. This means, for example, that a part of an AVP process is carried out in accordance with AVP Type 1 and another part of the AVP process is carried out in accordance with an AVP Type 2 or AVP Type 3. This means, for example, that an AVP process can be divided into AVP subprocesses that are each carried out in accordance with one of AVP types 1, 2 and 3.

AVP type 1 denotes a motor vehicle-centered AVP process. The primary responsibility for the AVP process rests with the motor vehicle.

AVP type 2 denotes an infrastructure-centered AVP process. The primary responsibility for the AVP process rests with the infrastructure, i.e. with the AVP system.

AVP type 3 denotes a motor vehicle-infrastructure-shared AVP process. Here, the primary responsibility for the AVP process is shared between the motor vehicle and the AVP system.

An AVP process comprises the following operations or functions:
1. Determining a target position, located within the parking lot, for the motor vehicle.
2. Planning a route from a starting position, within the parking lot, to the target position.
3. Detecting an object and/or an event and responding accordingly to a detected object and/or a detected event.
4. Locating the motor vehicle within the parking lot.
5. Calculating a target trajectory for the motor vehicle based on the planned route.
6. Controlling a lateral and longitudinal guidance of the motor vehicle based on the calculated target trajectory.

The following table indicates an assignment showing which of these procedures or functions are carried out, depending on the AVP type, by the motor vehicle or by the infrastructure-side AVP system, wherein “I” stands for “infrastructure,” i.e. for the infrastructure-side AVP system, and “K” stands for “motor vehicle”, so that “I” indicates that the process is carried out by the AVP system and “K” indicates that the process is carried out by the motor vehicle:

| Functions | AVP type 1 | AVP type 2 | AVP type 3 |
|---|---|---|---|
| Determining a target | I & K | I | I |
| position, located within | | | |
| the parking lot, for the | | | |
| motor vehicle. | | | |
| Planning a route from a | K | I | I |
| starting position, within | | | |
| the parking lot, to the | | | |
| target position. | | | |
| Detecting an object | K (& | I | I & K |
| and/or an event and a | optionally | | |
| corresponding reaction to | I) | | |
| a detected object and/or | | | |
| a detected event. | | | |
| Locating the motor | K | I | K |
| vehicle in the parking | | | |
| lot. | | | |
| Calculating a target | K | I | K |
| trajectory for the motor | | | |
| vehicle based on the | | | |
| planned route. | | | |
| Controlling a lateral and | K | K | K |
| longitudinal guidance of | | | |
| the motor vehicle based | | | |
| on the calculated target | | | |
| trajectory. | | | |

For each function, the above table thus indicates specifically for each AVP type whether the function is carried out by the infrastructure, i.e. by the infrastructure-side AVP system, or 5 by the motor vehicle. In some cases, it can be provided that the function is carried out by both the AVP system and the motor vehicle.

With respect to object detection and event detection for AVP type 1, it can optionally be provided that the AVP system of the infrastructure carries out this function as well, in addition to the motor vehicle.

The AVP types 1, 2, and 3 described here are also described in detail in ISO 23374.

According to one example embodiment of the method of the present invention, the motor vehicle is an at least highly automated motor vehicle. Such a motor vehicle is configured for at least highly automated guidance. Highly automated guidance corresponds to level of automation 4 as defined by the German Federal Highway Research Institute (BASt).

The motor vehicle being configured at least for highly automated guidance means that the motor vehicle is configured for both highly automated guidance and fully automated guidance. Fully automated guidance corresponds to level of automation 5 as defined by the BASt.

Highly automated guidance means that for a certain period of time in a specific situation (for example: driving on a freeway, driving in a parking lot, passing an object, driving within a travel lane defined by lane markings) a longitudinal and a lateral guidance of the motor vehicle are controlled automatically. A driver of the motor vehicle does not have to control the longitudinal and lateral guidance of the motor vehicle manually. The driver does not have to continuously monitor the automatic control of the longitudinal and lateral guidance in order to be able to intervene manually when necessary. If necessary, a take-over request to the driver to take over control of the longitudinal and lateral guidance is issued automatically, in particular issued with adequate time to respond. The driver therefore has to potentially be able to take control of the longitudinal and lateral guidance. Limits of the automatic control of the lateral and longitudinal guidance are recognized automatically. In highly automated guidance, it is not possible to automatically bring about a minimal risk state in every initial situation.

Fully automated guidance means that, in a specific situation (for example: driving on a freeway, driving in a parking lot, passing an object, driving within a travel lane defined by lane markings), longitudinal guidance and lateral guidance of the motor vehicle are controlled automatically. A driver of the motor vehicle does not have to control the longitudinal and lateral guidance of the motor vehicle manually. The driver does not have to monitor the automatic control of the longitudinal and lateral guidance in order to be able to intervene manually when necessary. Before the automatic control of the lateral and longitudinal guidance is ended, the driver is automatically prompted to take over the driving task (control of the lateral and longitudinal guidance of the motor vehicle), in particular with adequate time to respond. If the driver does not take over the driving task, the system automatically returns to a minimal risk state. Limits of the automatic control of the lateral and longitudinal guidance are recognized automatically. In all situations, it is possible to automatically return to a minimal risk system state.

The present invention is explained in more detail in the following with reference to preferred embodiment examples.

### BRIEF DESCRIPTION OF THE DRAWINGS

FIG. 1 shows a flow chart of an example method according to the first aspect of the present invention.

FIG. 2 shows a second example system according to the second aspect of the present invention.

FIG. 3 shows a machine-readable storage medium.

FIG. 4 shows service management platform in communication with an AVP service system, according to an example embodiment of the present invention.

FIG. 5 shows the service management platform of FIG. 4 in communication with the AVP service system according to FIG. 4 and a further service system, according to an example embodiment of the present invention.

FIG. 6 shows a block diagram illustrating an example of the here-described concept for managing at least one service for a motor vehicle, according to the present invention.

### DETAILED DESCRIPTION OF EXAMPLE EMBODIMENTS

In the following, the same reference signs can be used for the same features.

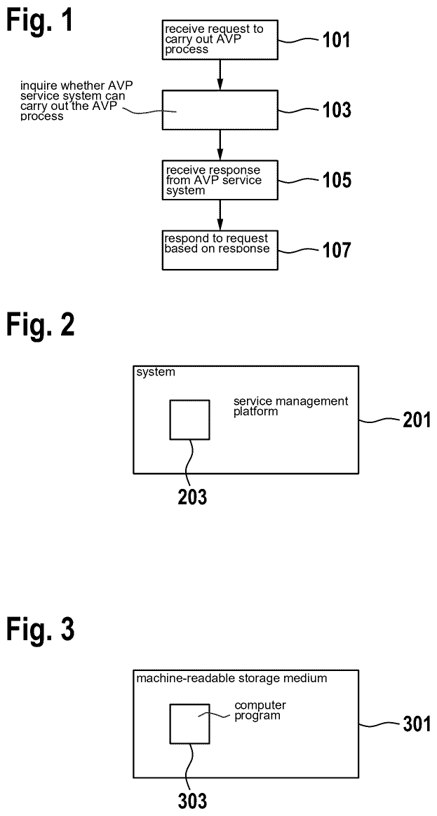

FIG. 1 shows a flow chart of a method for managing at least one service for a motor vehicle, comprising the following steps:
receiving 101 a request to carry out an AVP process for a motor vehicle to be parked within a parking lot by a service management platform,
inquiring 103 of an AVP service system by the service management platform whether the AVP service system can carry out the AVP process for the motor vehicle based on the request to carry out an AVP process within the parking lot,
receiving 105 a response from the AVP service system by the service management platform to the inquiry from the service management platform,
responding 107 to the request to carry out an AVP process by the service management platform based on the response from the AVP service system.

A response within the meaning of the description includes the information that the requested service, for example the AVP service, cannot be carried out, for instance.

FIG. 2 shows a system 201 for managing at least one service for a motor vehicle, comprising a service management platform 203 which is configured to carry out all steps of the method according to the first aspect.

FIG. 3 shows a machine-readable storage medium 301, on which the computer program 303 is stored. The computer program 303 comprises instructions that, when the computer program 303 is executed by a computer, carry out a method according to the first aspect.

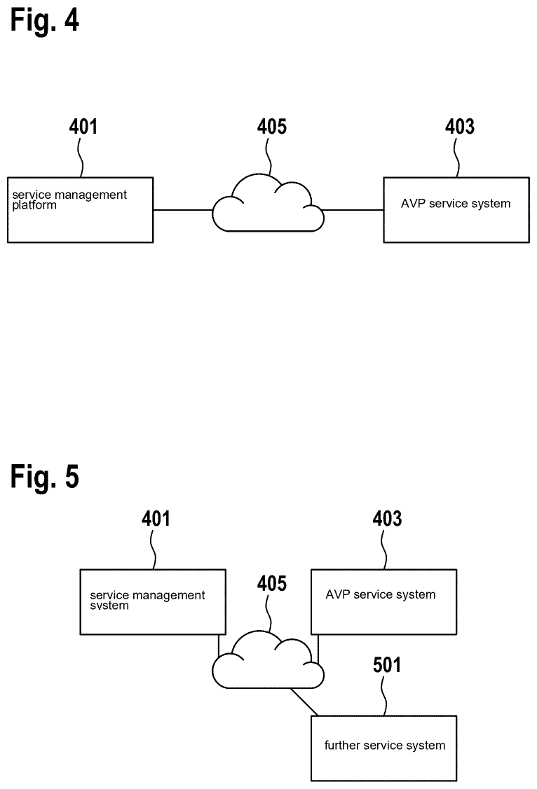

FIG. 4 shows a service management platform 401 and an AVP service system 403. The service management platform 401 and the AVP service system 403 communicate via a communication network 405.

FIG. 5 shows the elements of FIG. 4, and also a further service system 501 that communicates with the service management platform 401 via the communication network 405. FIG. 5 shows only one further service system 501. In a not depicted embodiment, a plurality of service systems that can communicate with the service management platform 401 via the communication network 405 are provided.

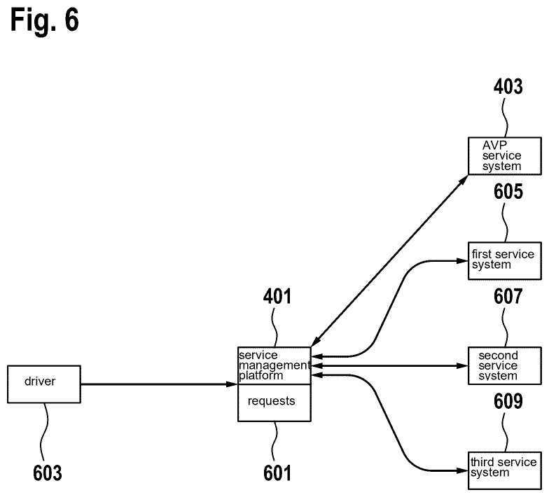

FIG. 6 shows a block diagram intended to explain the here-described concept using an example.

The service management platform 401 receives requests, symbolically identified by a block with the reference sign 601, from a driver, symbolically identified by a block with the reference sign 603, of a motor vehicle that is to be parked within a parking lot and is tasked to carry out an AVP process for said parking. The requests 601 thus include a request to carry out an AVP process for the motor vehicle parked within the parking lot. The requests 601 also include three further requests to carry out three further services. To carry out these services, i.e. the three further services and the AVP service, the AVP service system 403 and a first service system 605 and a second service system 607 and a third service system 609 are provided.

The requests 601 can already include or comprise all of the data needed to carry out these services. If data are still missing, the service management platform 401 can request said data from the driver 603 and/or from the motor vehicle, for example.

As an example, the first service system 605 provides washing the motor vehicle as a service. Purely as an example, the second service system 607 provides charging a drive battery of the motor vehicle as a service. Purely as an example, the third service system 609 provides cleaning an interior of the motor vehicle as a service.

The first service system 605 therefore does not need access to the interior of the motor vehicle. The third service system 609 does need access to the interior of the motor vehicle, however, so that access to a locking system of a motor vehicle door is needed. The second service system 607 doesn't need access to the interior of the motor vehicle either, so here too access to a locking system of a motor vehicle door is not needed. All three service systems 605, 607, 609 typically do not need access to a drive system and/or steering system and/or brake system and/or clutch system of the motor vehicle. The AVP service system 403, on the other hand, needs respective access to these motor vehicle components in order to carry out the AVP process.

According to the concept described here, it is provided that the service management platform 401 receives all of the data needed to carry out the services, but forwards to each service system 403, 605, 607, 609 only the data needed by the respective system to carry out the specific task.

This means that the service management platform 401 provides the individual service systems only the data they need to carry out the specific service. For example, the individual service systems not need payment data and/or personal data of the driver 603 if invoicing is carried out via the service management platform 401, which then pays the individual service systems.

The individual service systems need different data from the motor vehicle or for the motor vehicle, for instance. Such different data includes, for example, certificates and/or passwords and/or access keys and/or access data for individual motor vehicle functions and/or motor vehicle components. These data are managed in particular by the service management platform 401. An end customer, in the present example the driver 603, has only one point of contact, the service management platform 401, and his data are protected or anonymized as much as possible.

Having this single point of contact, the service management platform 401, in particular advantageously protects the end customer from many changes to the interfaces of the individual service systems. The communication between the service management platform 401 and the service systems is not relevant for the end customer. He does not have to worry about a respective technical implementation, so that changes to a corresponding interface do not affect him. This makes ordering a variety of services particularly easy for the end customer.

In one embodiment of the method, it is provided that, in addition to ordering and data management, the service management platform also handles the management of the services, including negotiating with the end customer.

This therefore means in particular that the service management platform analyzes whether the requested services are even possible, for instance. This means that the service management platform analyzes whether a service is currently available and/or whether the time needed to carry out the service can even be reconciled with the desired parking time of the motor vehicle. This means that if more time is needed to carry out the service than the motor vehicle is supposed to be parked, the requested service can of course not be carried out. The service management platform in particular analyzes and/or plans and/or monitors an optimum sequence for carrying out the services. The service management platform documents one or more of the method steps, for example. The service management platform, for instance, informs the end customer of any problems that may occur when the services are carried out.

Separating the service management platform from the service systems advantageously enables efficient collaboration between multiple partners that operate the individual service systems.

1-13. (canceled)

14. A method for managing at least one service for a motor vehicle, comprising the following steps:
receiving a request to carry out an AVP process for a motor vehicle to be parked within a parking lot by a service management platform;
inquiring of an AVP service system by the service management platform whether the AVP service system can carry out the AVP process for the motor vehicle based on the request to carry out an AVP process within the parking lot;
receiving a response from the AVP service system by the service management platform to the inquiry from the service management platform; and
responding to the request to carry out an AVP process by the service management platform based on the response from the AVP service system.

15. The method according to claim 14, wherein, upon a positive response from the AVP service system, data needed to carry out the AVP process are forwarded by the service management platform to the AVP service system when such data are already included in the request to carry out an AVP process, wherein, when data for the technical implementation of the AVP process are still missing, the still missing data are requested by the service management platform and, after receipt of the still missing data, the data are forwarded by the service management platform to the AVP service system.

16. The method according to claim 14, wherein at least one further request to carry out a specific service for the motor vehicle is received by the service management platform while the motor vehicle is within the parking lot, wherein the service management platform inquires of a further service system for carrying out the specific service whether the further service system can carry out the specific service based on the respective request while the motor vehicle is within the parking lot, wherein, upon a positive response, a stay of the motor vehicle is coordinated by the service management platform based on the request to carry out an AVP process and based on the at least one further request to carry out a specific service in order to enable both the carrying out of the AVP process by the AVP service system and the carrying out of the specific service by the further service system.

17. The method according to claim 16, wherein the coordinating includes the service management platform communicating a time of day and/or date to the AVP service system at which or on which the motor vehicle must be at a predetermined location in the parking lot at which the specific service is to be carried out by the further service system, so that the AVP service system can guide the motor vehicle in an at least highly automated manner to the predetermined location on time.

18. The method according to claim 16, wherein a plurality of further requests to carry out a respective specific service for the motor vehicle are received by the service management platform, wherein a plurality of respective further service systems for carrying out the respective specific service are inquired of by the service management platform whether the respective further service system can carry out the specific service based on the corresponding request, wherein, upon at least two positive responses, the coordinating includes the service management platform determining, based on at least one service parameter, a sequence according to which the services for the motor vehicle are to be carried out by the respective further service system.

19. The method according to claim 18, wherein the at least one service parameter is in each case an element selected from the following group of service parameters: utilization of the service systems; utilization of the AVP service system; capacity of the service systems; capacity of the AVP service system; current and/or future traffic within the parking lot; parking position of the motor vehicle within the parking lot; predetermined locations; expected duration of carrying out one of the services.

20. The method according to claim 16, wherein, upon a positive response from the respective further service system, data needed to carry out the respective further service are forwarded by the service management platform to the respective service system when such data are already included in the respective at least one further request to carry out a specific service, wherein, when data for the technical implementation of the respective further service are still missing, the still missing data are requested by the service management platform and after receipt of the still missing data, the are forwarded by the service management platform to the respective service system.

21. The method according to claim 16, wherein the needed data include one or more elements of the following data: (i) motor vehicle length; (ii) motor vehicle width; (iii) motor vehicle height; (iv) certificate and/or password and/or access key for accessing a motor vehicle component including a drive system and/or brake system and/or steering system and/or clutch system and/or lighting system and/or door lock and/or tank lock and/or charging opening lock and/or charging component and/or trunk lock and/or engine compartment lock and/or control unit and/or main control unit, which is needed to carry out the service or the AVP process; (v) motor vehicle turning radius; (vi) driving characteristics of the motor vehicle; (vii) level of automation.

22. The method according to claim 16, wherein (i) the service management platform, (ii) the AVP service system, and (iii) the service system or the service systems, are respectively implemented in a separate cloud infrastructure and/or in a common cloud infrastructure and/or in a stand-alone server and/or in a separate virtual machine.

23. The method according to claim 16, wherein the service is an element selected from the following group of services: (i) washing the motor vehicle; (ii) cleaning an interior of the motor vehicle; (iii) repairing the motor vehicle; (iv) servicing the motor vehicle; (v) charging a drive battery of the motor vehicle; (vi) refueling with gasoline, diesel, hydrogen, combustible gas; (vii) software update for software running on an electronic component of the motor vehicle; (viii) tire change; (ix) interior service, including arranging mail and/or a package in an interior of the motor vehicle.

24. A system for managing at least one service for a motor vehicle, comprising:
a service management platform configured to managing at least one service for a motor vehicle, the service management platform configured to:
receiving a request to carry out an AVP process for a motor vehicle to be parked within a parking lot by the service management platform;
inquiring of an AVP service system by the service management platform whether the AVP service system can carry out the AVP process for the motor vehicle based on the request to carry out an AVP process within the parking lot;
receiving a response from the AVP service system by the service management platform to the inquiry from the service management platform; and
responding to the request to carry out an AVP process by the service management platform based on the response from the AVP service system.

25. A non-transitory machine-readable storage medium on which is stored a computer program for managing at least one service for a motor vehicle, the computer program, when executed by a computer of a service management platform, causing the computer to perform the following steps:
receiving a request to carry out an AVP process for a motor vehicle to be parked within a parking lot by the service management platform;
inquiring of an AVP service system by the service management platform whether the AVP service system can carry out the AVP process for the motor vehicle based on the request to carry out an AVP process within the parking lot;
receiving a response from the AVP service system by the service management platform to the inquiry from the service management platform; and
responding to the request to carry out an AVP process by the service management platform based on the response from the AVP service system.
